(19) United States
(12) Patent Application Publication
(10) Pub. No.: US 2018/0191069 A1
(43) Pub. Date: Jul. 5, 2018

(54) NFC ANTENNA

(71) Applicant: BYD Company Limited, Guangdong (CN)

(72) Inventors: Yajuan Chen, Guangdong (CN); Munyong Choi, Guangdong (CN); Faping Wang, Guangdong (CN)

(21) Appl. No.: 15/739,196

(22) PCT Filed: Jun. 14, 2016
(86) PCT No.: PCT/CN2016/085722

§ 371 Date: Dec. 22, 2017

(30) Foreign Application Priority Data
Jun. 30, 2015 (CN) 201510390035.5

(51) Int. Cl. H01Q 7/00; H01Q 1/38

(52) U.S. Cl. CPC H01Q 7/00; H01Q 1/38

(57) ABSTRACT

An NFC antenna includes: at least two coils, where the at least two coils are disposed separately and are connected in series or in parallel to form an antenna circuit; at least one substrate, where the at least two coils are disposed on the at least one substrate, and two neighboring coils of the at least two coils are spaced by a substrate of the at least one substrate, projections of the two neighboring coils on the substrate of the at least one substrate at least partially overlap, the at least one substrate is provided with feed points connected to the antenna circuit, and a resonant frequency of the antenna circuit is 15-30 MHz.

### TECHNICAL FIELD

This disclosure relates to the field of wireless communications and, in particular, to an NFC antenna.

### BACKGROUND

Near field communication (NFC) is short-range high-frequency wireless technology that operates within a distance of 20 cm at a frequency of 13.56 MHz. An NFC antenna in conventional technologies uses a planar coil structure and has a relatively low inductance. When an existing NFC antenna approaches a high-loss environment such as metals, an inductance of the NFC antenna dramatically drops and, as a result, communication cannot be completed.

It could therefore be helpful to address at least one of the foregoing technical problems in conventional technologies to some extent.

### SUMMARY

We thus provide:
An NFC antenna that can produce a relatively high inductance with a relatively small size and can complete communication when approaching a high-loss environment such as metals.

The NFC antenna may include: at least two coils, where the at least two coils are disposed separately and are connected in series or in parallel to form an antenna circuit; at least one substrate, where the at least two coils are disposed on the at least one substrate, and two neighboring coils of the at least two coils are spaced by a substrate of the at least one substrate, projections of the two neighboring coils on the substrate of the at least one substrate at least partially overlap, the at least one substrate is provided with feed points connected to the antenna circuit, and a resonant frequency of the antenna circuit is 15-30 MHz.

The NFC antenna can produce a relatively high inductance with a relatively small size and can complete communication when approaching a high-loss environment such as metals.

In addition, the NFC antenna may also have the following additional technical features:
The resonant frequency of the antenna circuit may be 15-20 MHz.
The two neighboring coils may be connected through a via in the substrate of the at least one substrate.
A quantity of the feed points may be two, and the feed points may respectively be located at an initial end and a tail end of the antenna circuit.
The at least one substrate may be a flexible board or a rigid board.
The at least two coils may be conductive ink or silver paste printed on the at least one substrate.
The NFC antenna may include: one substrate, where the substrate has a first surface and a second surface that are opposite in a thickness direction of the substrate; and a first coil and a second coil, where the first coil is disposed on the first surface, the second coil is disposed on the second surface, the first coil and the second coil are connected, and projections of the first coil and the second coil on the substrate at least partially overlap.
The NFC antenna may further include two feed points, where the two feed points are disposed on the first surface separately, one of the two feed points is connected to an inner end of the first coil, the other of the two feed points is connected to an inner end of the second coil, and an outer end of the first coil is connected to an outer end of the second coil.
The substrate may have a dielectric constant of 4.0 and a thickness of 30 μm, and an overlapping area of the projections of the first coil and the second coil on the substrate is 34-135 mm².
The substrate may have a dielectric constant of 4.3 and a thickness of 30 μm, and an overlapping area of the projections of the first coil and the second coil on the substrate is 32-126 mm².

### BRIEF DESCRIPTION OF THE DRAWINGS

FIG. 1 is a schematic diagram of a front surface of an NFC antenna according to an example.

FIG. 2 is a schematic diagram of a back surface of an NFC antenna according to an example.

FIG. 3 is a perspective view of an NFC antenna according to an example.

FIG. 4 is a schematic diagram of a front surface of an NFC antenna according to another example.

FIG. 5 is a schematic diagram of a back surface of an NFC antenna according to another example.

FIG. 6 is a perspective view of an NFC antenna according to another example.

FIG. 7 shows an inductance-resonance curve of an NFC antenna according to an example.

### REFERENCE NUMERALS

NFC antenna 1
substrate 10
feed point 11
via 12
first coil 20
second coil 30

### DETAILED DESCRIPTION

The following describes selected constructions of our NFC antenna in detail. Examples are shown in the accompanying drawings, and same or similar reference numerals throughout the specification represent same or similar elements or elements having same or similar functions. The following examples described with reference to the accompanying drawings aim at the purpose of explaining our NFC antennas, and should not be understood as a limitation to this disclosure.

The following describes, with reference to the accompanying drawings, an NFC antenna 1 according to an example.

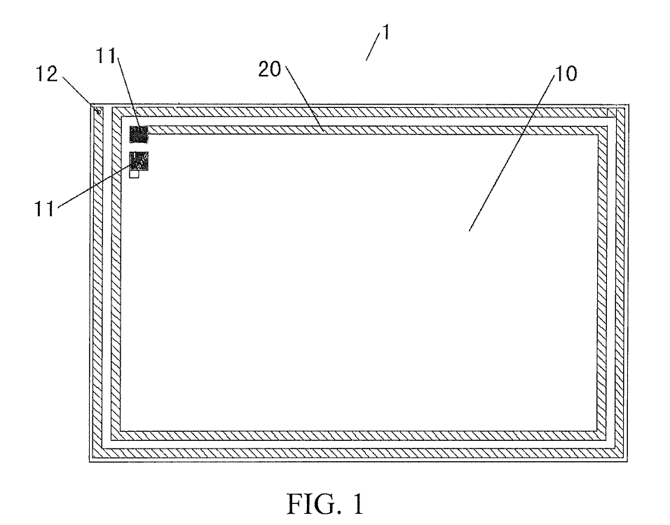

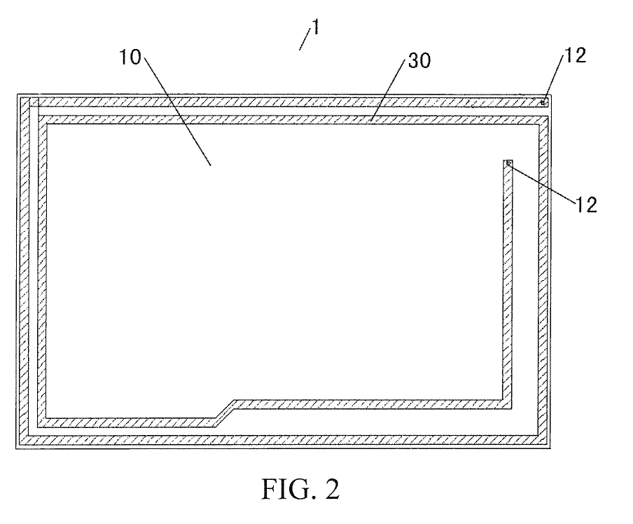

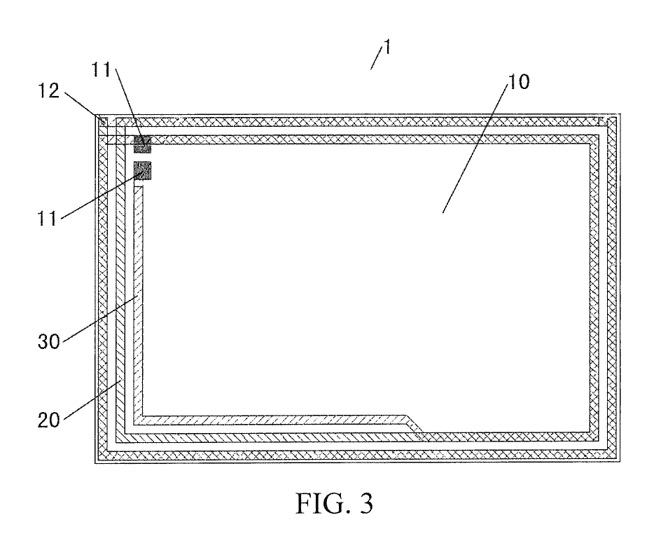

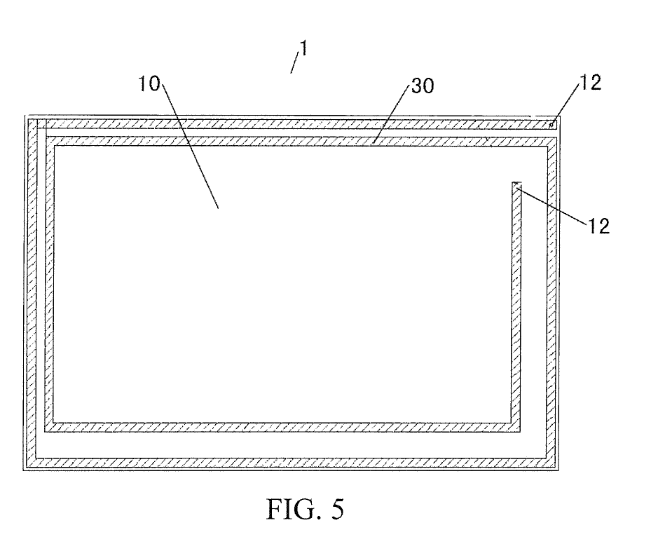

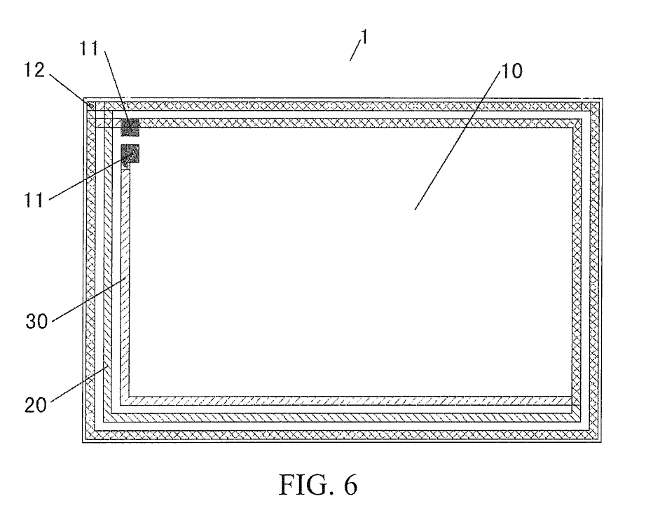

As shown in FIGS. 1 to 7, the NFC antenna 1 according to this example includes at least one substrate 10 and at least two coils.

The at least two coils are disposed separately and connected in series or in parallel to form an antenna circuit. The at least two coils are disposed on the at least one substrate 10, and two neighboring coils of the at least two coils are spaced by a substrate of the at least one substrate 10, projections of the two neighboring coils of the at least two coils on the substrate of the at least one substrate at least partially overlap, the at least one substrate 10 is provided with feed points 11 connected to the antenna circuit.

Those skilled in the art will understand that after different coils are stacked, when viewed from the same direction, flow directions of currents are the same, that is, the currents all flow clockwise or all flow counterclockwise. Hence, currents having a same flow direction produce magnetic fluxes having a same direction, and better performance is achieved by superposing the magnetic fluxes.

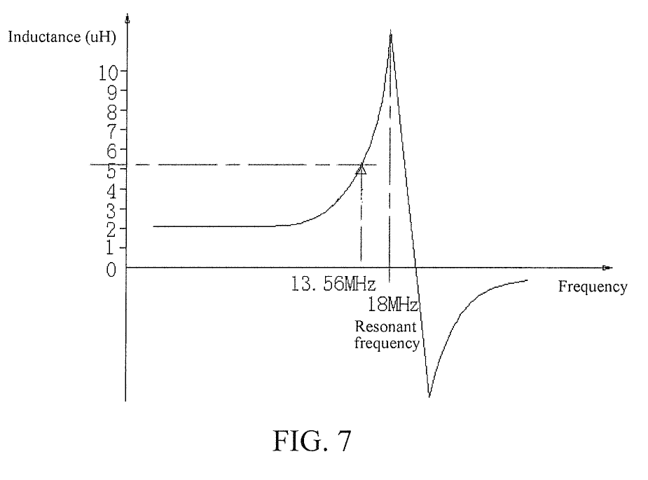

In the NFC antenna 1 according to this example, at least two coils are provided, and projections of the two neighboring coils of the at least two coils on the substrate of the at least one substrate 10 at least partially overlap. In this way, a capacitance is increased by adjusting an overlapping area of projections of the two neighboring coils on the substrate 10 to reduce a resonant frequency of the antenna circuit. Thus, the resonant frequency of the antenna circuit is approximate to 13.56 MHz to make an inductance of the antenna circuit have a sudden change near 13.56 MHz (as shown in FIG. 7), to obtain a relatively high inductance. Hence, the NFC antenna 1 can be applied when the NFC antenna 1 approaches a high-loss environment such as metals. After the antenna circuit is affected, the inductance of the NFC antenna 1 drops to a normal level to still complete wireless communication. Therefore, the NFC antenna 1 according to the examples can produce a relatively high inductance with a relatively small size and thus, can complete communication when approaching a high-loss environment such as metals.

The following describes, with reference to the accompanying drawings, the NFC antenna 1 according to specific examples.

In some specific examples, as shown in FIGS. 1 to 7, the NFC antenna 1 includes at least one substrate 10 and at least two coils.

To ensure that the inductance of the antenna circuit has a sudden change near 13.56 MHz, an overlapping area of projections of two neighboring coils on the substrate 10 is adjusted according to a formula f=1/[2π√(LC)] and C=ε*ε0*S/d so that the resonant frequency of the antenna circuit is 15-30 MHz. Preferably, the resonant frequency of the antenna circuit is 15-20 MHz.

Specifically, the two neighboring coils are connected through a via 12 in the substrate 10, a quantity of the feed points 11 is two, and the feed points 11 are respectively located at an initial end and a tail end of the antenna circuit.

Optionally, the NFC antenna 1 may be a flexible printed circuit board (FPC) or a printed circuit board (PCB) on the whole. In other words, the substrate 10 is a flexible board or a rigid board.

Our NFC antennas are not limited thereto. The at least two coils may also be conductive ink or silver paste printed on the substrate 10.

In some specific examples, as shown in FIGS. 1 to 6, the NFC antenna includes a substrate 10 and two coils, that is, a first coil 20 and a second coil 30. The substrate 10 has a first surface and a second surface that are opposite in a thickness direction of the substrate. The first coil 20 is winded around an outer periphery of the first surface of the substrate 10 along a circumferential direction of the substrate 10. The second coil 30 is winded around an outer periphery of the second surface of the substrate 10 along a circumferential direction of the substrate 10. The first coil 20 and the second coil 30 are connected, and projections of the first coil 20 and the second coil 30 on the substrate 10 at least partially overlap.

Specifically, an outer end of the first coil 20 and an outer end of the second coil 30 are connected through a via 12 in the substrate 10. Two feed points 11 are disposed on the first surface of the substrate 10 separately, one feed point 11 is connected to an inner end of the first coil 20, the other feed point 11 is connected to an inner end of the second coil 30 through the via 12 in the substrate 10.

In some specific examples as shown in FIGS. 1 to 3, the substrate 10 has a dielectric constant of 4.0 and a thickness of 30 μm, and an overlapping area of projections of the first coil 20 and the second coil 30 on the substrate 10 is 34-135 mm², to ensure that a resonant frequency of an antenna circuit is 15-20 MHz.

For example, the NFC antenna 1 is an FPC on the whole. The substrate 10 has a length of 30 mm and a width of 20 mm. The first coil 20 and the second coil 30 both have two turns. Line widths and line distances of the first coil 20 and the second coil 3 are all 0.5 mm. Hence, those skilled in the art can calculate inductance values of the coils according to the prior art. In addition, the substrate 10 is made of polyimide (PI) and has a thickness of 30 μm, and the resonant frequency of the antenna circuit is 20 MHz.

Further, C=90 picofarads may be obtained according to a formula f=1/[2π√(LC)]. Ignoring a capacitance between parallel lines, to make a planar capacitance between different layers be 90 picofarads, an S value of 76 mm² when a capacitance is 90 picofarads is obtained by calculation according to C=ε*ε0*S/d. Therefore, the overlapping area of the projections of the first coil 20 and the second coil 30 on the substrate 10 is adjusted to 76 mm².

Here, f is the resonant frequency of the antenna circuit, L is an inductance of the antenna circuit, ε is the dielectric constant 4.0 of the substrate 10, ε0 is a vacuum permittivity 8.85e-12 F/m, S is the overlapping area of the projections of the first coil 20 and the second coil 30 on the substrate 10, and d is a distance between the first coil 20 and the second coil 30 (that is, the thickness of the substrate 10).

The NFC antenna 1 according to this example and an existing NFC antenna are separately tested by using a network analyzer. The existing NFC antenna whose size is 30×20 mm, quantity of turns of the coils is 4, and line widths and line distances of the coils are all 0.5 mm is used as a test object. A resonant frequency of the existing antenna is 85 MHz.

It is obtained by testing that an inductance of the existing NFC antenna at 13.56 MHz is 0.8 microhenry, and an inductance of the NFC antenna 1 at 13.56 MHz is 2.3 microhenries.

By comparing the test results, the NFC antenna 1 according to this example uses a circuit of four turns to achieve an inductance of the existing NFC antenna that uses a circuit of 10 turns. Therefore, when the NFC antenna 1 according to this example and the existing NFC antenna have the same inductance, the size of the NFC antenna 1 according to this example may be reduced by ¾ compared to the size of the existing NFC antenna. In addition, when approaching a high-loss environment such as metals, the NFC antenna 1 may produce a relatively high inductance with a coil of fewer turns, for example, achieve 3-6 times of the inductance of the existing NFC antenna. Therefore, after the NFC antenna 1 is affected when approaching a high-loss environment such as metals, the inductance of the NFC antenna 1 dramatically drops to a normal level to still complete wireless communication.

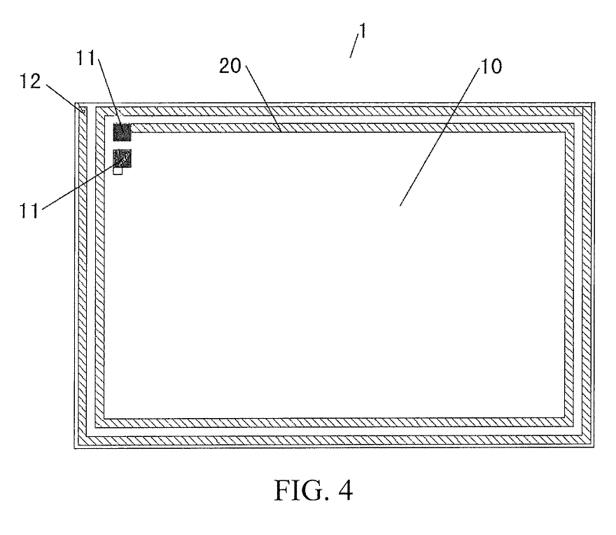

In some other specific examples of our NFC antennas, as shown in FIGS. 4 to 6, the substrate 10 has a dielectric constant of 4.3 and a thickness of 30 μm, and an overlapping area of projections of the first coil 20 and the second coil 30 on the substrate 10 is 32-126 mm² to ensure that the resonant frequency of the antenna circuit is 15-20 MHz.

For example, the NFC antenna 1 is a PCB on the whole. The substrate 10 has a length of 30 mm and a width of 20 mm. The first coil 20 and the second coil 30 both have two turns. Line widths and line distances of the first coil 20 and the second coil 3 are all 0.5 mm. Hence, those skilled in the art can calculate inductance values of the coils according to the prior art. In addition, the substrate 10 is a glass-reinforced epoxy laminated sheet (FR4) and has a thickness of 30 μm, and the resonant frequency of the antenna circuit is 20 MHz.

Further, C=90 picofarads may be obtained according to a formula f=1/[2π√(LC)]. Ignoring a capacitance between parallel lines to make a planar capacitance between different layers be 90 picofarads, an S value of 71 mm² when a capacitance is 90 picofarads is obtained by calculation according to C=ε*ε0*S/d. Therefore, the overlapping area of the projections of the first coil 20 and the second coil 30 on the substrate 10 is adjusted to 71 mm².

Here, f is the resonant frequency of the antenna circuit, L is an inductance of the antenna circuit, ε is the dielectric constant 4.3 of the substrate 10, 60 is a vacuum permittivity 8.85e-12 F/m, S is the overlapping area of the projections of the first coil 20 and the second coil 30 on the substrate 10, and d is a distance between the first coil 20 and the second coil 30 (that is, the thickness of the substrate 10).

The NFC antenna 1 according to this example and an existing NFC antenna are separately tested by using a network analyzer. The existing NFC antenna whose size is 30×20 mm, quantity of turns of the coils is 4, and line widths and line distances of the coils are all 0.5 mm is used as a test object. A resonant frequency of the existing antenna is 85 MHz.

It is obtained by testing that an inductance of the existing NFC antenna at 13.56 MHz is 0.8 microhenry, and an inductance of the NFC antenna 1 according to this example at 13.56 MHz is 2.4 microhenries.

By comparing the test results, the NFC antenna 1 according to this example uses a circuit of four turns to achieve an inductance of the existing NFC antenna that uses a circuit of 10 turns. Therefore, when the NFC antenna 1 according to this example and the existing NFC antenna have the same inductance, the size of the NFC antenna 1 according to this example may be reduced by ¾ compared with the size of the existing NFC antenna. In addition, when approaching a high-loss environment such as metals, the NFC antenna 1 according to this example may produce a relatively high inductance with a coil of fewer turns, for example, achieve 3-6 times of the inductance of the existing NFC antenna. Therefore, after the NFC antenna 1 according to this example is affected when approaching a high-loss environment such as metals, the inductance of the NFC antenna 1 dramatically drops to a normal level to still complete wireless communication.

Other structures and operations of the NFC antenna 1 according to the examples are known to those skilled in the art and are not described in detail herein.

In this description, it should be understood that orientation or position relationships indicated by terms “center,” “longitudinal,” “transverse,” “length,” “width,” “thickness,” “on,” “under,” “front,” “rear,” “left,” “right,” “vertical,” “horizontal,” “top,” “bottom,” “inside,” “outside,” “clockwise,” “counterclockwise” or the like are orientation or position relationships shown based on the accompanying drawings, which are only for the purpose of describing our NFC antennas and simplifying the description, but do not indicate or imply that indicated apparatuses or elements necessarily have particular orientations or are necessarily constructed and operated at particular orientations. Therefore, the orientation or position relationships should not be understood as a limitation.

In addition, terms “first” and “second” are only for descriptive purpose and cannot be understood as indicating or implying relative importance or implying a quantity of the indicated technical features. Therefore, features defining “first” and “second” can explicitly or implicitly include one or more of the features. In description of this disclosure, “multiple” means at least two, such as two and three unless it is specifically defined otherwise.

Unless explicitly stipulated and defined otherwise, terms such as “mount,” “link,” “connect” and “fasten” should be understood in broad sense and, for example, may be a fixed connection or a detachable connection or integration, may be a mechanical connection or an electric connection, may be a direct connection or an indirect connection by using an intermediate medium, and may be communication within two elements or an interaction relationship of two elements. Those skilled in the art will understand specific meanings of the terms according to specific situations.

Unless explicitly stipulated and defined otherwise, a first feature being “on” or “under” a second feature may include direct contact of the first and second features or contact of the first and second features through another feature between them rather than direct contact. In addition, the first feature being “on,” “above” and “up” the second feature includes the first feature being right above or diagonally above the second feature or only indicates that a horizontal height of the first feature is larger than that of the second feature. In addition, the first feature being “under,” “below” and “down” the second feature includes the first feature being right below or diagonally below the second feature or only indicates that a horizontal height of the first feature is smaller than that of the second feature.

Description of reference terms such as “one embodiment,” “some embodiments,” “example,” “specific example” or “some examples” means including specific features, structures, materials, or features described in the embodiment or example in at least one embodiment or example herein. In this specification, schematic expressions for the foregoing terms are not necessarily specific to the same embodiment or example. In addition, the described specific features, structures, materials, or features can be combined in a proper manner in any one or more embodiments or examples. In addition, those skilled in the art can join or combine different embodiments or examples described herein.

Although the examples are shown and described in the above, it can be understood that the foregoing examples cannot be understood as a limitation to this disclosure. Those skilled in the art can change, modify, replace, and deform the foregoing examples within the scope of this disclosure.

1-10. (canceled)

11. An NFC antenna comprising:
at least two coils that are disposed separately and connected in series or in parallel to form an antenna circuit;
at least one substrate, wherein the at least two coils are disposed on the at least one substrate, and two neighboring coils of the at least two coils are spaced by a substrate of the at least one substrate, projections of the two neighboring coils on the substrate of the at least one substrate at least partially overlap, the at least one substrate is provided with feed points connected to the antenna circuit, and a resonant frequency of the antenna circuit is 15-30 MHz.

12. The NFC antenna according to claim 11, wherein the resonant frequency of the antenna circuit is 15-20 MHz.

13. The NFC antenna according to claim 11, wherein the two neighboring coils are connected through a via in the substrate of the at least one substrate.

14. The NFC antenna according to claim 11, wherein a quantity of the feed points is two, and the feed points are respectively located at an initial end and a tail end of the antenna circuit.

15. The NFC antenna according to claim 11, wherein the at least one substrate is a flexible board or a rigid board.

16. The NFC antenna according to claim 11, wherein the at least two coils are conductive ink or silver paste printed on the at least one substrate.

17. The NFC antenna according to claim 11, further comprising:
one substrate, wherein the substrate has a first surface and a second surface that are opposite in a thickness direction of the substrate; and
a first coil and a second coil, wherein the first coil is disposed on the first surface, the second coil is disposed on the second surface, the first coil and the second coil are connected, and projections of the first coil and the second coil on the substrate at least partially overlap.

18. The NFC antenna according to claim 17, further comprising two feed points, wherein the two feed points are disposed on the first surface separately, one of the two feed points is connected to an inner end of the first coil, the other of the two feed points is connected to an inner end of the second coil, and an outer end of the first coil is connected to an outer end of the second coil.

19. The NFC antenna according to claim 17, wherein the substrate has a dielectric constant of 4.0 and a thickness of 30 μm, and an overlapping area of the projections of the first coil and the second coil on the substrate is 34-135 mm².

20. The NFC antenna according to claim 17, wherein the substrate has a dielectric constant of 4.3 and a thickness of 30 μm, and an area of an overlapped part of the projections of the first coil and the second coil on the substrate is 32-126 mm².

21. The NFC antenna according to claim 18, wherein the substrate has a dielectric constant of 4.0 and a thickness of 30 μm, and an overlapping area of the projections of the first coil and the second coil on the substrate is 34-135 mm².

22. The NFC antenna according to claim 18, wherein the substrate has a dielectric constant of 4.3 and a thickness of 30 μm, and an area of an overlapped part of the projections of the first coil and the second coil on the substrate is 32-126 mm².

23. The NFC antenna according to claim 12, wherein the two neighboring coils are connected through a via in the substrate of the at least one substrate.

24. The NFC antenna according to claim 12, wherein a quantity of the feed points is two, and the feed points are respectively located at an initial end and a tail end of the antenna circuit.

25. The NFC antenna according to claim 13, wherein a quantity of the feed points is two, and the feed points are respectively located at an initial end and a tail end of the antenna circuit.

26. The NFC antenna according to claim 12, wherein the at least one substrate is a flexible board or a rigid board.

27. The NFC antenna according to claim 13, wherein the at least one substrate is a flexible board or a rigid board.

28. The NFC antenna according to claim 14, wherein the at least one substrate is a flexible board or a rigid board.

29. The NFC antenna according to claim 12, wherein the at least two coils are conductive ink or silver paste printed on the at least one substrate.

30. The NFC antenna according to claim 13, wherein the at least two coils are conductive ink or silver paste printed on the at least one substrate.
